(19) United States
(12) Patent Application Publication
(10) Pub. No.: US 2024/0346879 A1
(43) Pub. Date: Oct. 17, 2024

(54) MACHINE LEARNING OF GAMBLING BEHAVIOR

(71) Applicant: Malcolm Rutherford, Las Vegas, NV (US)

(72) Inventor: Malcolm Rutherford, Las Vegas, NV (US)

(21) Appl. No.: 18/420,668

(22) Filed: Jan. 23, 2024

Related U.S. Application Data
(63) Continuation of application No. 16/721,666, filed on Dec. 19, 2019, now abandoned.
Application No. 16/721,666 is a continuation of application No. PCT/US18/38376, filed on Jun. 19, 2018.
(60) Provisional application No. 62/522,061, filed on Jun. 19, 2017.
(60) Provisional application No. 62/685,311, filed on Jun. 15, 2018.

(51) Int. Cl. G07F 17/32; G07F 17/42

(52) U.S. Cl. CPC G07F 17/3237; G07F 17/3234; G07F 17/3241; G07F 17/42

(57) ABSTRACT

Technologies and implementations for learning of gambling behavior including detection of potential nefarious activities associated with gambling. The learning of gambling behavior may utilize various recognition methodologies such as, but not limited to, currency recognition and tracing and facial recognition.

### RELATED APPLICATION

This application claims benefit of priority to U.S. Provisional Patent Application Ser. No. 62/522,061, filed on Jun. 19, 2017, titled Machine Learning of Gambling Behavior and U.S. Provisional Patent Application Ser. No. 62/685,311, filed on Jun. 15, 2018, titled Machine Learning of Gambling Behavior, both of which are incorporated herein by reference in their entirety.

### INFORMATION

Unless otherwise indicated herein, the approaches described in this section are not prior art to the claims in this application and are not admitted to be prior art by inclusion in this section.

Gambling has become a favorite past time of many people. Commonly, gambling includes transactions of money. Because gambling may involve money, some people have found ways to use gambling related activities for nefarious activities. For example, a person may use gambling activities to launder money. Laundering money may include activities to circumvent anti-money laundering (AML) rules by “cleaning” the sources of the money. Money from illicit sources (e.g., money from drug dealings, money from illegal gambling, and money from various criminal activities) may be laundered by a person (e.g., a player in a gambling context) with the use of gambling facilities. Because gambling facilities may have multitude of transactions involving money, monitoring and detecting this type of nefarious activities may be difficult.

### SUMMARY

Described herein are various illustrative methods for machine learning of gambling behavior. Example methods may include a method for learning a gambling behavior of a person. The method may include receiving, by a computing device, an indication of cash being deposited at an electronic gaming machine (EGM) by the person and storing, by the computing device, cash data in a storage medium, the cash data including at least one of a value of the deposited cash or an identifying indicator of the cash. The method may include transmitting, by the computing device, a command to a video capture device to capture an image of the person and storing, by the computing device, the captured image of the person in the storage medium. The method may further include receiving, by the computing device, an indication of a request to generate a ticket in/ticket out (TITO) voucher, the TITO voucher having associated TITO data, the TITO data including at least one of a value of the TITO voucher, a time of generation of the TITO voucher, or a location of the EGM and comparing, by the computing device, the stored cash data with the TITO data. The method may additionally include determining, by the computing device, if the comparing of the cash data with the TITO data indicates a predetermined potential activity and flagging, by the computing device, the stored image of the person for further investigation if it is determined that the comparing of the cash data with the TITO data indicates the predetermined potential activity.

The present disclosure also describes various example electronic gaming machines (EGM) that may include a video capture device, a currency validator, a storage medium, and a processor communicatively coupled to the video capture device, the currency validator, and the storage medium. The processor included in the EGM may be configured to receive an indication of cash being deposited at the EGM by a person and store cash data in the storage medium, the cash data including at least one of a value of the deposited cash or an identifying indicator of cash. The processor may be configured to transmit a command to the video capture device to capture an image of the person, store the captured image of the person in the storage medium, and receive an indication of a request to generate a ticket in/ticket out (TITO) voucher, the TITO voucher having associated TITO data, the TITO data including at least one of a value of the TITO voucher, a time of generation of the TITO voucher, or a location of the EGM. Additionally, the processor may be configured to compare the stored cash data with the TITO data, determine if the compared cash data with the TITO data indicates a predetermined potential activity, and flag the stored image of the person for further investigation if it is determined that the compared cash data with the TITO data indicates the predetermined potential activity.

The foregoing summary is illustrative only and not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Subject matter is particularly pointed out and distinctly claimed in the concluding portion of the specification. The foregoing and other features of the present disclosure will become more fully apparent from the following description and appended claims, taken in conjunction with the accompanying drawings. Understanding that these drawings depict only several embodiments in accordance with the disclosure, and are therefore, not to be considered limiting of its scope. The disclosure will be described with additional specificity and detail through use of the accompanying drawings.

In the drawings:

FIG. 1 illustrates a block diagram of a system for machine learning of gambling behavior, in accordance with various embodiments;

FIG. 2 illustrates an operational flow for machine learning of gambling behavior, in accordance with at least some of the embodiments described herein;

FIG. 3 illustrates an example computer program product, arranged in accordance with at least some embodiments described herein; and

FIG. 4 is a block diagram illustrating an example computing device, arranged in accordance with at least some embodiments described herein.

### DETAILED DESCRIPTION

The following description sets forth various examples along with specific details to provide a thorough understanding of claimed subject matter. It will be understood by those skilled in the art that claimed subject matter might be practiced without some or more of the specific details disclosed herein. Further, in some circumstances, well-known methods, procedures, systems, components and/or circuits have not been described in detail, in order to avoid unnecessarily obscuring claimed subject matter.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

This disclosure is drawn, inter alia, to methods, apparatus, systems and computer readable media related to machine learning of gambling behavior.

Prior to turning to the detailed description of the disclosure, a non-limiting scenario may be illustrated to facilitate a full appreciation of the claimed subject matter. In this non-limiting scenario, a setting may be a gambling facility such as, but not limited to, a casino. A person (hereon out, a player) may use the casino to launder money from illegal activities (e.g., clean the money). The player may have the money in the form of currency notes (herein on out, bills). For ease of understanding the non-limiting scenario, references may be made to an example currency such as, but not limited to, U.S. dollar. In this non-limiting scenario, the player may have received 1000 dollars from illicit activities. Since the money may be from illicit activities, the player may choose to launder the money in the casino.

Continuing with the non-limiting scenario, the player may enter the casino with the 1000 dollars and may decide to play an electronic gaming machine (EGM) such as, but not limited to, an electronic slot machine. The player may insert the bills into a bill acceptor of the EGM. The bill acceptor may include a currency validator such as, but not limited to, a cash validator (e.g., the player may insert 10 bills of 100 dollars each). The validator may confirm that the bills are correctly read (i.e., each inserted bill is of 100 dollars). Additionally, the validator may be able to identify each of the bills (e.g., serial number). The data regarding the deposited cash may be stored. Additionally, the EGM may include a video capture device, where the video capture device may be utilized to capture images and/or videos (hereon, out images) of the player. The images of the player may be stored. As alluded to, the player may not be in the casino to play the games, but instead, the player may be in the casino for nefarious purposes. Accordingly, the player may play the EGM for a relatively short period time.

In this non-limiting example scenario, the player may play the slot machine for an unusual short period of time such as, but not limited to, 5 to 10 minutes. After this short period of time, the player may cash out (e.g., request the EGM to generate a ticket in/ticket out (TITO) voucher). The TITO voucher may be used to exchange the TITO voucher for cash. Since the player may be laundering the money, in addition to the unusual short period of time, the TITO voucher may indicate that the player gambled an unusual low amount of money such as, but not limited to, 1 dollar. As a result, the TITO voucher may indicate that the cash out value may be 999 dollars. The player may redeem the TITO voucher at an automated TITO receiver kiosk to exchange the TITO voucher for 999 dollars in cash. Alternatively, the player may redeem the TITO voucher at a cash booth of the casino for 999 dollars in cash. Effectively, the 1000 dollars from illicit activities may be laundered with a loss of 1 dollar. Of course, there is a chance that the player may actually win with the 1 dollar gambled. However, this situation may be addressed by the claimed subject matter herein.

Continuing with the non-limiting example scenario, it may be determined that the player played the EGM an unusual short period of time and that the player gambled an unusual low amount of money by comparing the cash data and the TITO data. Accordingly, it may be determined that the player may be potentially using the casino to launder money. The image of the player may be flagged as a player of potential interest for nefarious activities.

Once the player has been flagged, the system may recognize the player the next time the player enters the casino and/or inserts bills in to an EGM. Because the image of the player is stored and flagged, image capture devices in any establishment may recognize the player (e.g., casino video capture devices may recognize the player in the casino area and/or a video capture device of an EGM may recognize the player as the player's image is captured. Accordingly, it may be determined that the behavior of the player may be learned, and from this determination, certain activities associated with the player may be detected.

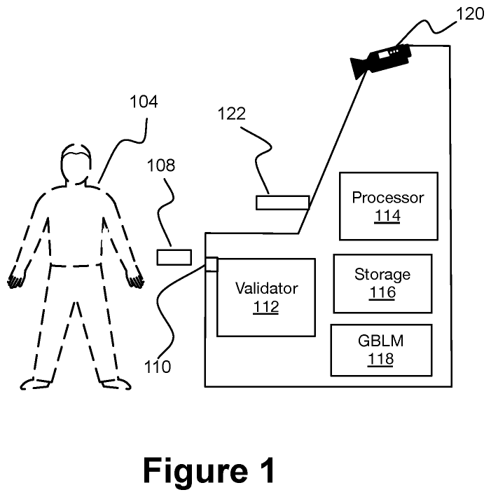

FIG. 1 illustrates a block diagram of a system for machine learning of gambling behavior, in accordance with various embodiments. In FIG. 1, a system 100 for machine learning of gambling may include an electronic gaming machine (EGM) 102 and a person (player) 104. The player 104 may insert money (e.g., cash bills) 108 into a bill acceptor 110 of the EGM 102. Additionally, illustrated in FIG. 1, the EGM 102 may include a cash validator 112, a processor 114, a storage medium 116, a gambling behavior learning module (GBLM) 118, and a video capture device 120. Even though the components such as, but not limited to, the processor 114, storage medium 116, GBLM 118 and video capture device 120 may be shown as included in the EGM 102, it is but one example of the disclosed subject matter. Some other examples may have these components as separate components being communicatively coupled to the EGM such as the examples described herein. Accordingly, the claimed subject matter is not limited in these respects.

In FIG. 1, the player 104 may insert bills 108 into the bill acceptor 110, and the cash validator 112 may verify denomination of the bills 108, value of the inserted bills, facilitate identification of the bills 108, and/or include an identifying indicator of the bills 108. The data associated with the bills 108 (cash data) may be stored in the storage medium 116. A command may be transmitted to the video capture device 120 by the processor 114 to capture an image of the player 104, and the captured image may be stored in the storage medium 116. The person 104 may indicate a request to cash out by requesting generation of a ticket in/ticket out (TITO) voucher 122. The TITO voucher may include some data such as, but not limited to, a value of the TITO voucher, a time of printing of the TITO voucher, and/or a location of the EGM that printed the TITO voucher.

The processor 114 may compare the cash data with the TITO data to determine if the comparison may indicate a predetermined potential activity (e.g., money laundering). As previously described, the comparison may include indications of activities such as, but not limited to, amount inserted into the EGM, the amount played, and/or the amount of time played. If it is determined that the comparison of the cash data and the TITO data may indicate some potential nefarious activity, the image of the person may be flagged. Accordingly, the gambling behavior of the person may be learned by the system 100.

In one example, the EGM 102 may not include the video capture device, but instead, the video capture device may be proximate to the EGM 102 (e.g., a video capture device having a field of view of the EGM 102). In one example, the flagging of the image of the player 104 may include application of facial recognition algorithms for the player 104. Accordingly, in another example, the player 104 (having the been flagged) may enter another establishment such as, but not limited to, another casino. The player 104 may insert bills into another EGM at the other casino, and because the gambling behavior of the player has been learned, an alert may be transmitted to personnel at the other casino. The alert may facilitate careful watch of the player 104.

It should be appreciated that the above non-limiting example scenario and the examples described with respect to FIG. 1 have been in the context of a casino, it is clearly contemplated that the disclose subject matter may include a wide variety to machines, where bills may be accepted such as, but not limited to, vending machines, coin change machines, cash-out kiosks, and the like. Accordingly, the claimed subject matter is not limited in these respects.

It should be appreciated by one of ordinary skilled in the relevant art that a wide variety of facial recognition methodologies may be employed including facial recognition methodologies having AI capabilities to facilitate at least some of the functionality described herein such as, but not limited to, AI capable processors available from Intel Corporation of Santa Clara, California (e.g., Nervana™ type processors), available from Nvidia Corporation of Santa Clara, California (e.g., Volta™ type processors), available from Apple Company of Cupertino, California (e.g., A11 Bionic™ type processors), available from Huawei Technologies Company of Shenzen, Guangdong, China (e.g., Kirin™ type processors), available from Advanced Micro Devices, Inc. of Sunnyvale, California (e.g., Radeon Instinct™ type processors), available from Samsung of Seoul, South Korea (e.g., Exynos™ type processors), and so forth. Accordingly, the claimed subject matter is not limited in these respects. The utilization of facial recognition may facilitate machine learning of gambling behavior of the player 104 as described herein.

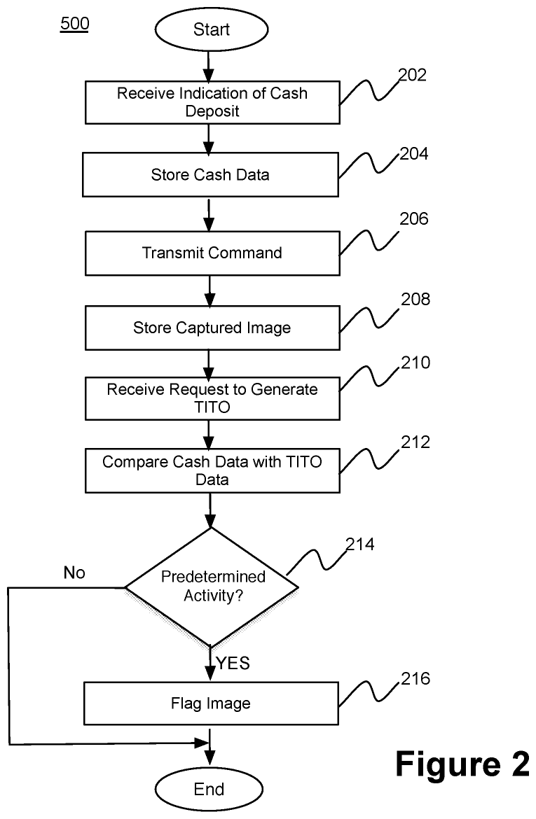

FIG. 2 illustrates an operational flow for machine learning of gambling behavior, in accordance with at least some of the embodiments described herein. In some portions of the description, illustrative implementations of the method are described with reference to the system 100 depicted in FIG. 1. However, the described embodiments are not limited to these depictions. More specifically, some elements depicted in FIG. 1 may be omitted from some implementations of the methods detailed herein. Furthermore, other elements not depicted in FIG. 1 may be used to implement example methods detailed herein.

Additionally, FIG. 2 employs block diagrams to illustrate the example methods detailed therein. These block diagrams may set out various functional blocks or actions that may be described as processing steps, functional operations, events and/or acts, etc., and may be performed by hardware, software, and/or firmware. Numerous alternatives to the functional blocks detailed may be practiced in various implementations. For example, intervening actions not shown in the figures and/or additional actions not shown in the figures may be employed and/or some of the actions shown in the figures may be eliminated. In some examples, the actions shown in one figure may be operated using techniques discussed with respect to another figure. Additionally, in some examples, the actions shown in these figures may be operated using parallel processing techniques. The above described, and other not described, rearrangements, substitutions, changes, modifications, etc., may be made without departing from the scope of claimed subject matter.

In some examples, operational flow 200 may be employed as part of machine learning of gambling behavior. Beginning at block 202 (“Receive an Indication of Cash Deposit”), the GLBM 118 may receive an indication of cash being deposited at the EGM by a person.

Continuing from block 202 to block 204 (“Store Cash Data”), the GBLM 118 may store cash data in the storage medium, the cash data including at least one of a value of the deposited cash or an identifying indicator of cash.

Continuing from block 204 to block 206 (“Transmit Command”) as part of the machine learning protocol, the GBLM 118 may transmit a command to the video capture device to capture an image of the person.

Continuing from block 206 to block 208 (“Store Captured Image”), the GBLM 118 may store the captured image of the person in the storage medium.

Continuing from block 208 to block 210 (“Receive Request to Generate TITO”), the GBLM 118 may receive an indication of a request to generate a ticket in/ticket out (TITO) voucher, the TITO voucher having associated TITO data, the TITO data including at least one of a value of the TITO voucher, a time of generation of the TITO voucher, or a location of the EGM.

Continuing from block 210 to block 212 (“Compare Cash Data with TITO Data”), the GBLM 118 may compare the stored cash data with the TITO data.

Continuing from block 210 to decision block 214 (“Predetermined Activity”), the GBLM 118 may determine if the compared cash data with the TITO data indicates a predetermined potential activity.

If at decision block 214, if it is determined that the compared cash data with the TITO data indicates the predetermined potential activity, the operation may continue from decision block to 214 to operational block 216 (“Flag Image”). In one example, the GBLM 118 may employ facial recognition methodologies including facial recognition methodologies having AI capabilities.

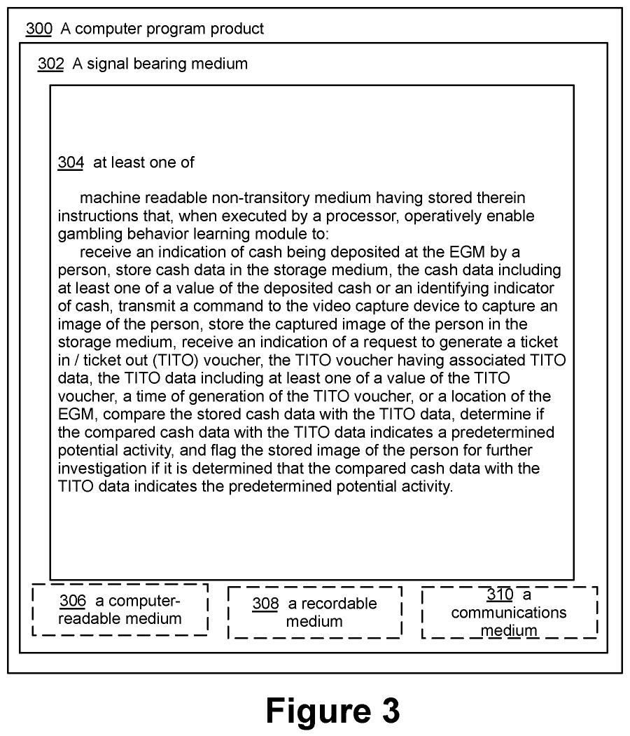

In general, the operational flow described with respect to FIG. 2 and elsewhere herein may be implemented as a computer program product, executable on any suitable computing system, or the like. For example, a computer program product for coordinating a number of drones may be provided. Example computer program products are described with respect to FIG. 3 and elsewhere herein.

FIG. 3 illustrates an example computer program product 300, arranged in accordance with at least some embodiments described herein. Computer program product 300 may include machine readable non-transitory medium having stored therein instructions that, when executed, cause the machine to learn gambling behavior according to the processes and methods discussed herein. Computer program product 300 may include a signal bearing medium 302. Signal bearing medium 302 may include one or more machine-readable instructions 304, which, when executed by one or more processors, may operatively enable a computing device to provide the functionality described herein. In various examples, some or all of the machine-readable instructions may be used by the devices discussed herein.

In some examples, the machine readable instructions 304 may receive an indication of cash being deposited at an electronic gaming machine (EGM) by a person and store cash data in the storage medium, the cash data including at least one of a value of the deposited cash or an identifying indicator of cash. The machine readable instructions 304 may be configured to transmit a command to the video capture device to capture an image of the person, store the captured image of the person in the storage medium, and receive an indication of a request to generate a ticket in/ticket out (TITO) voucher, the TITO voucher having associated TITO data, the TITO data including at least one of a value of the TITO voucher, a time of generation of the TITO voucher, or a location of the EGM. Additionally, the machine readable instructions 304 may be configured to compare the stored cash data with the TITO data, determine if the compared cash data with the TITO data indicates a predetermined potential activity, and flag the stored image of the person for further investigation if it is determined that the compared cash data with the TITO data indicates the predetermined potential activity.

In some implementations, signal bearing medium 302 may encompass a computer-readable medium 306, such as, but not limited to, a hard disk drive, a Compact Disc (CD), a Digital Versatile Disk (DVD), a digital tape, memory, etc. In some implementations, the signal bearing medium 302 may encompass a recordable medium 308, such as, but not limited to, memory, read/write (R/W) CDs, R/W DVDs, etc. In some implementations, the signal bearing medium 302 may encompass a communications medium 310, such as, but not limited to, a digital and/or an analog communication medium (e.g., a fiber optic cable, a waveguide, a wired communication link, a wireless communication link, etc.). In some examples, the signal bearing medium 302 may encompass a machine readable non-transitory medium.

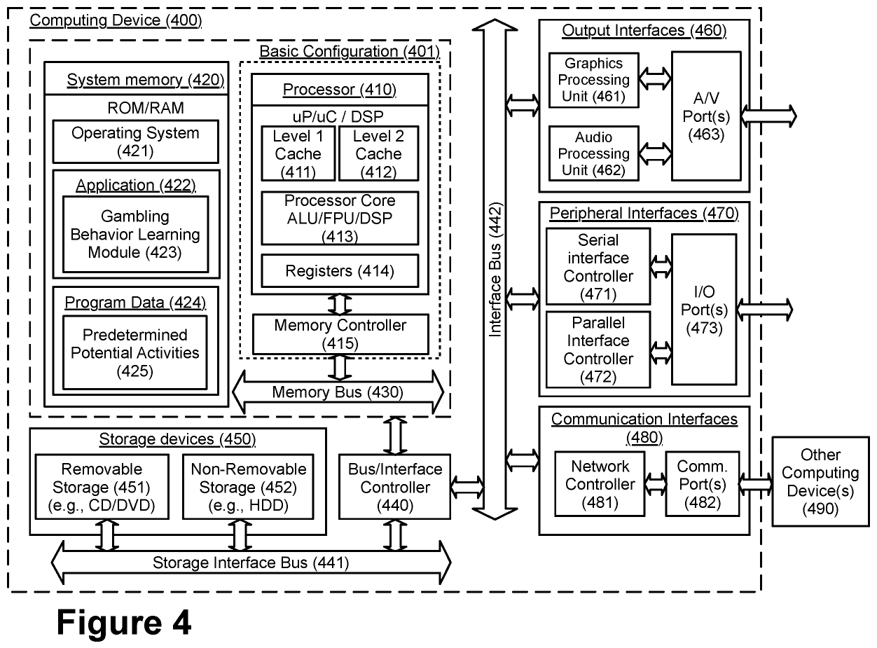

In general, the methods described with respect to FIG. 2 and elsewhere herein may be implemented in any suitable computing system and/or interactive electronic game. Example systems may be described with respect to FIG. 4 and elsewhere herein. In general, the system may be configured to learn gambling behavior.

FIG. 4 is a block diagram illustrating an example computing device 400, arranged in accordance with at least some embodiments described herein. In various examples, computing device 400 may be configured to learn gambling behavior as discussed herein. In one example of a basic configuration 401, computing device 400 may include one or more processors 410 and a system memory 420. A memory bus 430 can be used for communicating between the one or more processors 410 and the system memory 420.

Depending on the desired configuration, the one or more processors 410 may be of any type including but not limited to a microprocessor (UP), a microcontroller (C), a digital signal processor (DSP), or any combination thereof. Additionally, the microprocessors may include AI capable processors such as those previously mentioned. The one or more processors 410 may include one or more levels of caching, such as a level one cache 411 and a level two cache 412, a processor core 413, and registers 414. The processor core 413 can include an arithmetic logic unit (ALU), a floating point unit (FPU), a digital signal processing core (DSP Core), or any combination thereof. A memory controller 415 can also be used with the one or more processors 410, or in some implementations the memory controller 415 can be an internal part of the processor 410.

Depending on the desired configuration, the system memory 420 may be of any type including but not limited to volatile memory (such as RAM), non-volatile memory (such as ROM, flash memory, etc.) or any combination thereof. The system memory 420 may include an operating system 421, one or more applications 422, and program data 424. The one or more applications 422 may include gambling behavior learning application 423 that can be arranged to perform the functions, actions, and/or operations as described herein including the functional blocks, actions, and/or operations described herein. The program data 424 may include predetermined potential activity data 425 for use with the gambling behavior learning module application 423. In some example embodiments, the one or more applications 422 may be arranged to operate with the program data 424 on the operating system 421. This described basic configuration 401 is illustrated in FIG. 4 by those components within dashed line.

Computing device 400 may have additional features or functionality, and additional interfaces to facilitate communications between the basic configuration 401 and any required devices and interfaces. For example, a bus/interface controller 440 may be used to facilitate communications between the basic configuration 401 and one or more data storage devices 450 via a storage interface bus 441. The one or more data storage devices 450 may be removable storage devices 451, non-removable storage devices 452, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 420, the removable storage 451 and the non-removable storage 452 are all examples of computer storage media. The computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by the computing device 400. Any such computer storage media may be part of the computing device 400.

The computing device 400 may also include an interface bus 442 for facilitating communication from various interface devices (e.g., output interfaces, peripheral interfaces, and communication interfaces) to the basic configuration 401 via the bus/interface controller 440. Example output interfaces 460 may include a graphics processing unit 461 and an audio processing unit 462, which may be configured to communicate to various external devices such as a display or speakers via one or more A/V ports 463. Example peripheral interfaces 470 may include a serial interface controller 471 or a parallel interface controller 472, which may be configured to communicate with external devices such as input devices (e.g., keyboard, mouse, pen, voice input device, touch input device, etc.) or other peripheral devices (e.g., printer, scanner, etc.) via one or more I/O ports 473. An example communication interface 480 includes a network controller 481, which may be arranged to facilitate communications with one or more other computing devices 483 over a network communication via one or more communication ports 482. A communication connection is one example of a communication media. The communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), infrared (IR) and other wireless media. The term computer readable media as used herein may include both storage media and communication media.

The computing device 400 may be implemented as a portion of a small-form factor portable (or mobile) electronic device such as a cell phone, a mobile phone, a tablet device, a laptop computer, a personal data assistant (PDA), a personal media player device, a wireless web-watch device, a personal headset device, an application specific device, or a hybrid device that includes any of the above functions. The computing device 400 may also be implemented as a personal computer including both laptop computer and non-laptop computer configurations. In addition, the computing device 400 may be implemented as part of a wireless base station or other wireless system or device.

Some portions of the foregoing detailed description are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is here, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing device, that manipulates or transforms data represented as physical electronic or magnetic quantities within memories, registers, or other information storage devices, transmission devices, or display devices of the computing device.

The claimed subject matter is not limited in scope to the particular implementations described herein. For example, some implementations may be in hardware, such as employed to operate on a device or combination of devices, for example, whereas other implementations may be in software and/or firmware. Likewise, although claimed subject matter is not limited in scope in this respect, some implementations may include one or more articles, such as a signal bearing medium, a storage medium and/or storage media. This storage media, such as CD-ROMs, computer disks, flash memory, or the like, for example, may have instructions stored thereon, that, when executed by a computing device, such as a computing system, computing platform, or other system, for example, may result in execution of a processor in accordance with the claimed subject matter, such as one of the implementations previously described, for example. As one possibility, a computing device may include one or more processing units or processors, one or more input/output devices, such as a display, a keyboard and/or a mouse, and one or more memories, such as static random access memory, dynamic random access memory, flash memory, and/or a hard drive.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be affected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a flexible disk, a hard disk drive (HDD), a Compact Disc (CD), a Digital Versatile Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to subject matter containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Reference in the specification to “an implementation,” “one implementation,” “some implementations,” or “other implementations” may mean that a particular feature, structure, or characteristic described in connection with one or more implementations may be included in at least some implementations, but not necessarily in all implementations. The various appearances of “an implementation,” “one implementation,” or “some implementations” in the preceding description are not necessarily all referring to the same implementations.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter also may include all implementations falling within the scope of the appended claims, and equivalents thereof.

What is claimed:

1. A method for learning a gambling behavior of a person comprising:
receiving, by a computing device, an indication of cash being deposited at an electronic gaming machine (EGM) by the person;
storing, by the computing device, cash data in a storage medium, the cash data including at least one of a value of the deposited cash or an identifying indicator of the cash;
transmitting, by the computing device, a command to a video capture device to capture an image of the person;
storing, by the computing device, the captured image of the person in the storage medium;
receiving, by the computing device, an indication of a request to generate a ticket in/ticket out (TITO) voucher, the TITO voucher having associated TITO data, the TITO data including at least one of a value of the TITO voucher, a time of generation of the TITO voucher, or a location of the EGM;
comparing, by the computing device, the stored cash data with the TITO data;
determining, by the computing device, if the comparing of the cash data with the TITO data indicates a predetermined potential activity; and
flagging, by the computing device, the stored image of the person for further investigation if it is determined that the comparing of the cash data with the TITO data indicates the predetermined potential activity.

2. The method of claim 1, wherein receiving the indication of cash being deposited comprises receiving an indication of cash being deposited at a currency validator included in the EGM.

3. The method of claim 1, wherein transmitting the command to the video capture device comprises transmitting the command to a video capture device proximate to the EGM.

4. The method of claim 1, wherein comparing the stored cash data with the TITO data comprises determining a difference between the value of the deposited cash with the value of the TITO voucher.

5. The method of claim 1, wherein comparing the stored cash data with the TITO data comprises determining a time difference between when the EGM accepted the cash and when the TITO voucher was generated.

6. The method of claim 1 further comprising:
recognizing, by the computing device, the person at a second EGM;
receiving, by the computing device, an indication of cash being deposited at the second EGM by the person;
comparing, by the computing device, second cash data from the second EGM with the cash data; and
transmitting, by the computing device, an alert to personnel associated with the second EGM.

7. An electronic gaming machine (EGM) comprising:
a video capture device;
a currency validator;
a storage medium;
a gambling behavior learning module (GBLM);
a processor communicatively coupled to the video capture device, the currency validator, the storage medium, and the GBLM; and
a non-transitory machine readable medium having stored therein a plurality of instructions, which, if executed by the processor, operatively enable a computing device to receive an indication of cash being deposited at the EGM by a person, store cash data in the storage medium, the cash data including at least one of a value of the deposited cash or an identifying indicator of cash, transmit a command to the video capture device to capture an image of the person, store the captured image of the person in the storage medium, receive an indication of a request to generate a ticket in/ticket out (TITO) voucher, the TITO voucher having associated TITO data, the TITO data including at least one of a value of the TITO voucher, a time of generation of the TITO voucher, or a location of the EGM, compare the stored cash data with the TITO data, determine if the compared cash data with the TITO data indicates a predetermined potential activity, and flag the stored image of the person for further investigation if it is determined that the compared cash data with the TITO data indicates the predetermined potential activity.

8. A system comprising:
an electronic gaming machine (EGM);
a processor communicatively coupled to the EGM;
a storage medium communicatively coupled to the processor;
a video capture device communicatively coupled to the processor;
a gambling behavior learning module (GBLM) communicatively coupled to the processor; and
a non-transitory machine readable medium having stored therein a plurality of instructions, which, if executed by the processor, operatively enable a computing device to receive an indication of cash being deposited at the EGM by a person, store cash data in the storage medium, the cash data including at least one of a value of the deposited cash or an identifying indicator of cash, transmit a command to the video capture device to capture an image of the person, store the captured image of the person in the storage medium, receive an indication of a request to generate a ticket in/ticket out (TITO) voucher, the TITO voucher having associated TITO data, the TITO data including at least one of a value of the TITO voucher, a time of generation of the TITO voucher, or a location of the EGM, compare the stored cash data with the TITO data, determine if the compared cash data with the TITO data indicates a predetermined potential activity, and flag the stored image of the person for further investigation if it is determined that the compared cash data with the TITO data indicates the predetermined potential activity.
